(19) United States
(12) Patent Application Publication
(10) Pub. No.: US 2025/0392926 A1
(43) Pub. Date: Dec. 25, 2025

(54) Enhancement of Quality of Service for Communications-Intensive Applications by Automatically Associating the Applications with Premium Access

(71) Applicant: Google LLC, Mountain View, CA (US)

(72) Inventors: Jayachandran Chinnakkannu, San Ramon, CA (US); Pavan Santhana Krishna Nuggehalli, San Carlos, CA (US); Sathish Karunakaran, Los Altos, CA (US); Amruth Ramachandran, Fremont, CA (US); Amol Tuli, Dublin, CA (US)

(73) Assignee: Google LLC, Mountain View, CA (US)

(21) Appl. No.: 19/317,494

(22) Filed: Sep. 3, 2025

Related U.S. Application Data
(60) Provisional application No. 63/864,520, filed on Aug. 15, 2025.

(51) Int. Cl. H04W 24/02

(52) U.S. Cl. CPC H04W 24/02

(57) ABSTRACT

This document describes systems and techniques for enhancing Quality of Service (QoS) of communications-intensive applications by automatically associating the applications with premium access. For example, a connectivity service provides applications with standard access or premium access to communications services, the premium access operable to provide increased bandwidth or reduced latency. A premium access controller associated with the connectivity service identifies the communications-intensive application for association with the premium access and a connectivity manager interacts with the applications to identify the communications-intensive application and to cause the premium access controller of the connectivity service to automatically associate the communications-intensive application with the premium access.

### CROSS-REFERENCE TO RELATED APPLICATION

This application claims the benefit of U.S. Provisional Patent Application Ser. No. 63/864,520 filed on Aug. 15, 2025, the disclosure of which is incorporated by reference herein in its entirety.

### SUMMARY

This document describes systems and techniques for enhancing Quality of Service (QoS) of communications-intensive applications in a communications device by automatically associating the applications with premium access. Some applications executing on a communications device such as a mobile telephone, including over-the-top (OTT) video, voice, and messaging applications, may offer enhanced functionality with greater bandwidth and reduced latency. Although mobile networks, including 4G, LTE, and 5G networks, may offer premium access to network services to improve bandwidth and reduce latency, requesting and using premium access may require significant modification to those applications to request or use premium access.

For example, a connectivity service provides applications with standard access or premium access to communications services, the premium access operable to provide increased bandwidth or reduced latency. A premium access controller associated with the connectivity service identifies the communications-intensive application for association with the premium access and a connectivity manager interacts with the applications to identify the communications-intensive application and to cause the premium access controller of the connectivity service to automatically associate the communications-intensive application with the premium access.

This Summary is provided to introduce systems and techniques for enhancing QoS of communications-intensive applications in a communications device by automatically associating the applications with premium access, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for enhancing QoS of communications-intensive applications in a communications device by automatically associating the applications with premium access are described in this document with reference to the following Drawings. The same numbers are used throughout the drawings to reference like features and components.

FIG. 1 is a block diagram of a communications system including a connectivity manager that works with a connectivity service to automatically associate communications-intensive applications with premium access;

FIG. 2 is a schematic diagram of types of premium access to network services in different types of mobile telephone networks;

FIG. 3 is a schematic diagram of types of premium access to network services in networks other than mobile telephone networks;

FIG. 4 is a block diagram of a communications architecture of a communications device that incorporates the communications system with the connectivity manager of FIG. 1;

FIG. 5 is a schematic diagram of a system in which the connectivity manager of FIG. 1 coordinates with applications and the connectivity service to provide for premium access;

FIG. 6 is a schematic diagram of interaction of the connectivity manager of FIG. 1 with applications and data associated with or generated by the applications to identify communications-intensive applications to be associated with premium access;

FIGS. 7A-6D are schematic diagrams representing an example of the connectivity manager of FIG. 1 associating applications with premium access and standard access network services;

FIGS. 8A-8B are screen displays from a communications device representing enhanced functionality of a communications-intensive application associated with premium access to network services;

FIG. 9 is a call flow diagram representing operation of the connectivity manager of FIG. 1 in associating a communications-intensive application with standard access at boot-up then with premium access when the communications-intensive application is active;

FIG. 10 is a call flow diagram representing operation of the connectivity manager of FIG. 1 in associating a communications-intensive application directly with premium access on an as-needed basis when the communications-intensive application when the application is active; and

FIG. 11 is a flow diagram of an example method of automatically associating a communications-intensive application with premium access to network services.

### DETAILED DESCRIPTION

### Overview

Mobile carriers may provide their own audio or audiovisual telecommunications services. The mobile carriers typically utilize a prioritized level of access to network communications services to improve QoS of their telecommunications services. Nonetheless, many users prefer to use third-party “over-the-top” (OTT) applications such as WhatsApp®, Zoom®, and other communications applications.

Mobile carriers may make available premium access for use by communications-intensive applications other than their own audio or audiovisual telecommunications services over fourth generation (4G), long-term evolution (LTE), and fifth generation (5G) networks. However, for third-party applications to utilize premium access to network services, the third-party applications have to be modified to use premium access. For example, to use premium access, an OTT developer may have to modify the network stack and/or other aspects of their applications, and may have to provide and maintain multiple versions of their applications for each of multiple mobile telephone carriers.

To address this problem, disclosed systems and techniques provide a connectivity manager or continuity management that recognize communications-intensive applications and automatically associate them with available premium access without the communications-intensive applications being modified. As a result, developers' communication-intensive applications may take advantage of premium access without creating and maintaining multiple versions of their applications for multiple mobile carriers to provide users with a positive user experience.

This document describes systems and techniques for enhancing QoS of communications-intensive applications in a communications device by automatically associating the applications with premium access. For example, a connectivity service provides applications with standard access or premium access to communications services, the premium access operable to provide increased bandwidth or reduced latency. A premium access controller associated with the connectivity service identifies the communications-intensive application for association with the premium access and a connectivity manager interacts with the applications to identify the communications-intensive application and to cause the premium access controller of the connectivity service to automatically associate the communications-intensive application with the premium access.

### Implementation of a Connectivity Manager

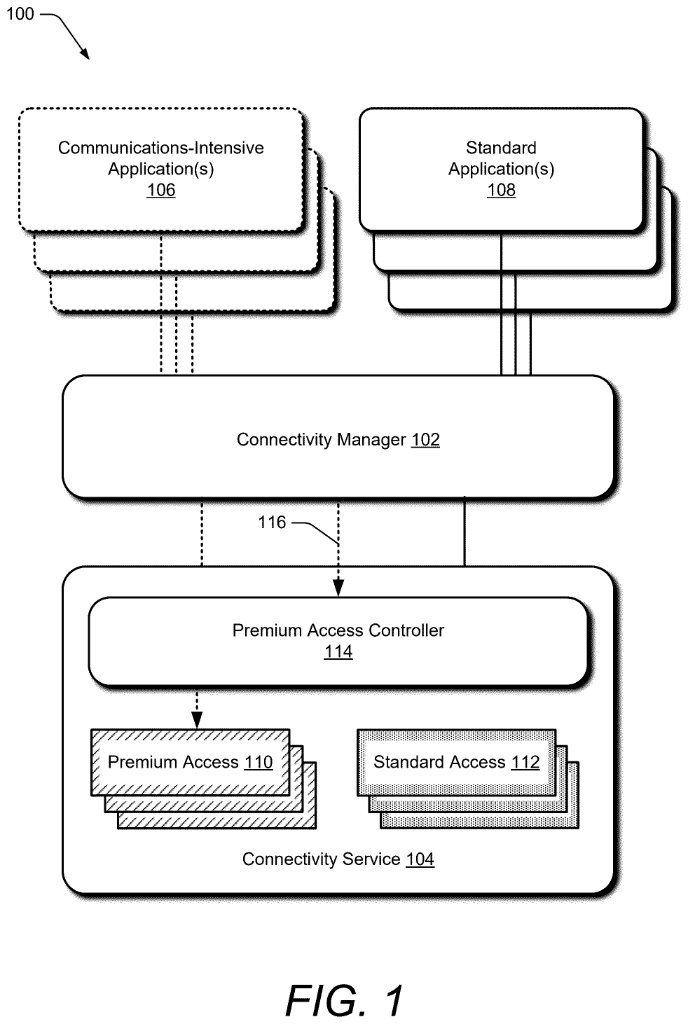

FIG. 1 shows a block diagram of a communications system 100 including a connectivity manager 102 that works with a connectivity service 104 to automatically associate different types of applications 106 and 108 with the premium access 110 or the standard access 112. The applications 106 and 108 include communications-intensive applications 106 that need or would benefit from the capabilities of the premium access 110, such as high-bandwidth and/or low latency communications, as described further below. Other applications, which may utilize network communications but may not need or significantly benefit from the premium access 110, may be categorized as standard applications 108, as also described further below. Communications-intensive applications 106 are outlined with a dotted outline to visually differentiate them from standard applications 108 throughout the figures.

Conventionally, as previously described, accessing the premium access 110 via the connectivity service 104 requires developers of the applications 106 and 108 to modify their respective applications 106 and 108 if they desire that their applications 106 and 108 to request and utilize the premium access 110. For example, to associate with the premium access 110, developers would need to modify a network stack or other attributes of their applications.

For standard applications 108, such as email applications, e-commerce applications, and other applications that do not require or would not significantly benefit from association with the premium access 110 with higher bandwidth and reduced latency, there is little motivation to modify and maintain the standard applications 108 to associate with the premium access 110. By contrast, communications-intensive applications 106, for example, OTT audio and audiovisual communications may provide enhanced functionality if associated with the premium access 110, thus, there would be motivation to associate their applications 106 with the premium access 110 but confront development and maintenance challenges in doing so.

However, the connectivity manager 102 works with the applications 106 and 108 and with the connectivity service 104 to automatically associate the communications-intensive applications 106 with the premium access 110 without requiring modification of the communications-intensive applications 106 to use the premium access 110. The connectivity service 104 includes a premium access controller 114 that is configured to identify the communications-intensive applications 106 and to cause the communications-intensive applications 106 to be associated with the premium access 110. More specifically, the premium access controller is responsive to control signals 116 from the connectivity manager 102 that specify or designate the communications-intensive applications 106 that would benefit from association with the premium access 110 and, thus, communicate network traffic to and/or from the communications-intensive applications 106 over the premium access 110. Thus, when one or more communications-intensive applications 106 are active, the connectivity manager 102 may issue control signals 116 to the premium access controller 114 of the connectivity service 104 to associate the one or more communications-intensive applications 106 with the premium access 110 when possible.

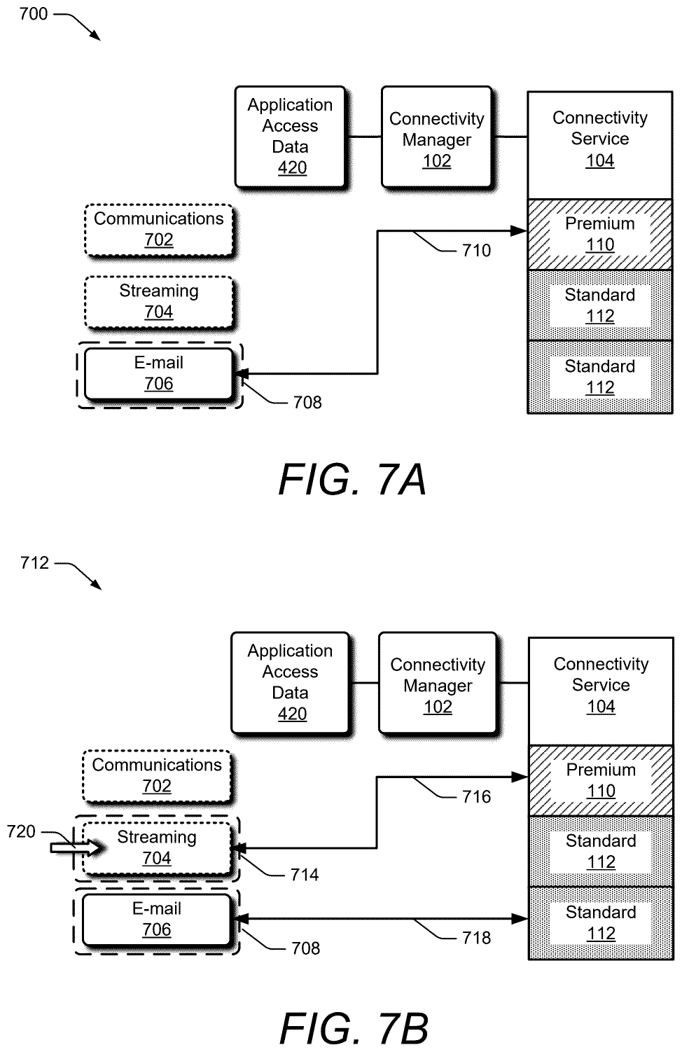

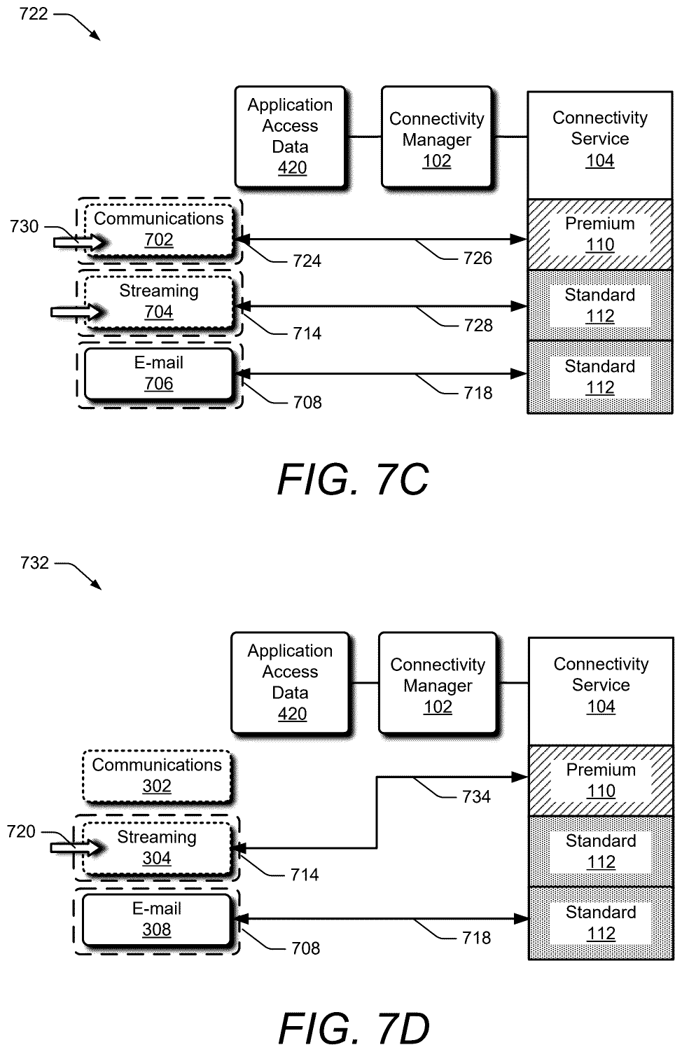

It should be noted that, although the connectivity manager 102 may automatically associate the communications-intensive applications 106 with the premium access 110, the connectivity manager may not associate the communications-intensive applications 106 with the premium access 110 transparently to the communications-intensive applications 106. It may be desirable to notify the communications-intensive applications 106 and/or its users (not shown in FIG. 1) that it is associated with the premium access 110, as further described below with reference to FIGS. 7A and 7B. For example, it may be desirable to communicate to the communications-intensive applications 106 that they are associated with the premium access 110 to take advantage of, for example, greater video resolution that may be supported by higher-bandwidth of the premium access 110. Correspondingly, as a point of user satisfaction with the mobile telephone carrier, it may be desirable to provide an indication to the user that the user is taking advantage of the premium access 110 from the mobile carrier.

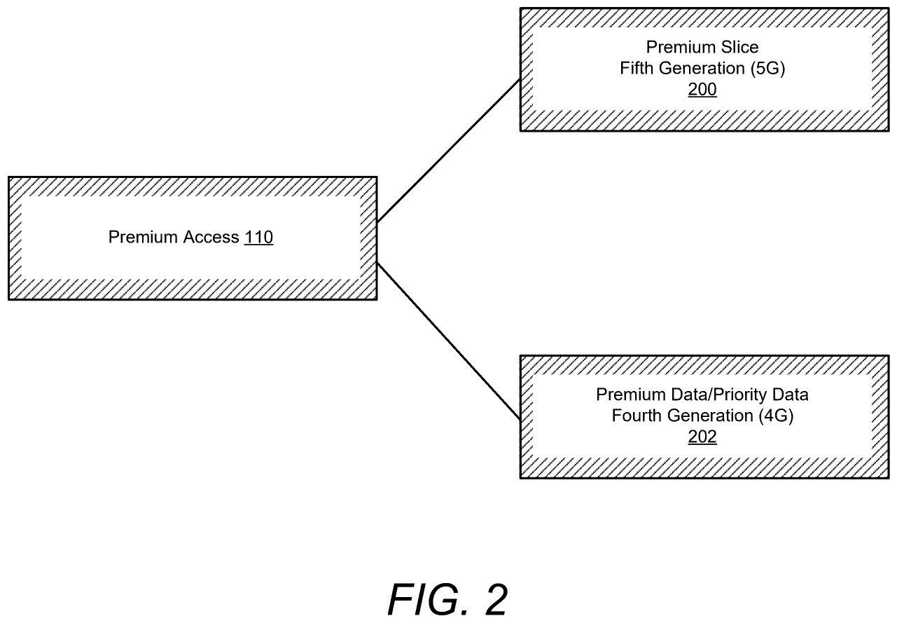

FIG. 2 is a block diagram of examples of types of the premium access 110 that may be available under different mobile networks. For example, the premium access 110 may include a premium slice 200 in a fifth-generation (5G) network. The premium slice 200 includes a dedicated portion of the 5G network infrastructure that is optimized for high-speed data transfer to support enhanced application performance. Premium access may include premium connectivity or priority data 202 in a fourth-generation (4G) network. Unlike the premium slice 200 in a 5G network, the premium data or priority data 202 does not refer to a dedicated portion of a network that is optimized for high-speed data transfer. However, the premium data or priority data 202 is prioritized over other network traffic in the 4G network, resulting in higher data speeds for the premium data or priority data 202.

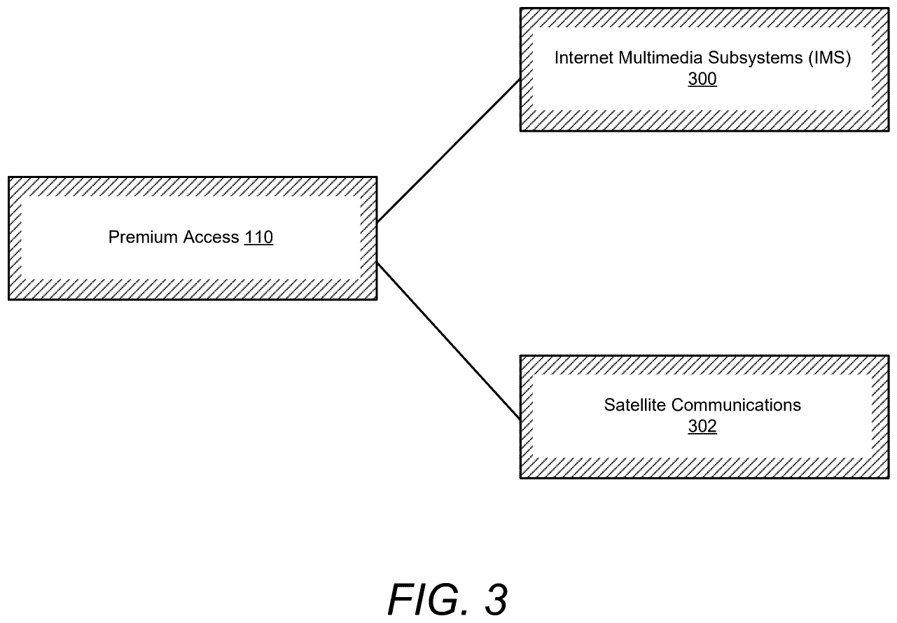

FIG. 3 is a block diagram of examples of types of the premium access 110 that may be available under networks other than mobile telephone networks. For example, the premium access 110 may include routing data for communications-intensive applications 106 through an Internet Multimedia Subsystem (IMS) network 300 that operates over Internet-Protocol (IP) networks. For another example, the premium access 110 may include a satellite network that provides a preferred high-bandwidth and/or low-latency access. In addition to the examples of FIGS. 2 and 3, any other accessible network that provides a preferred higher-bandwidth and/or low-latency access may provide the premium access 110 that may be used with systems and methods disclosed herein.

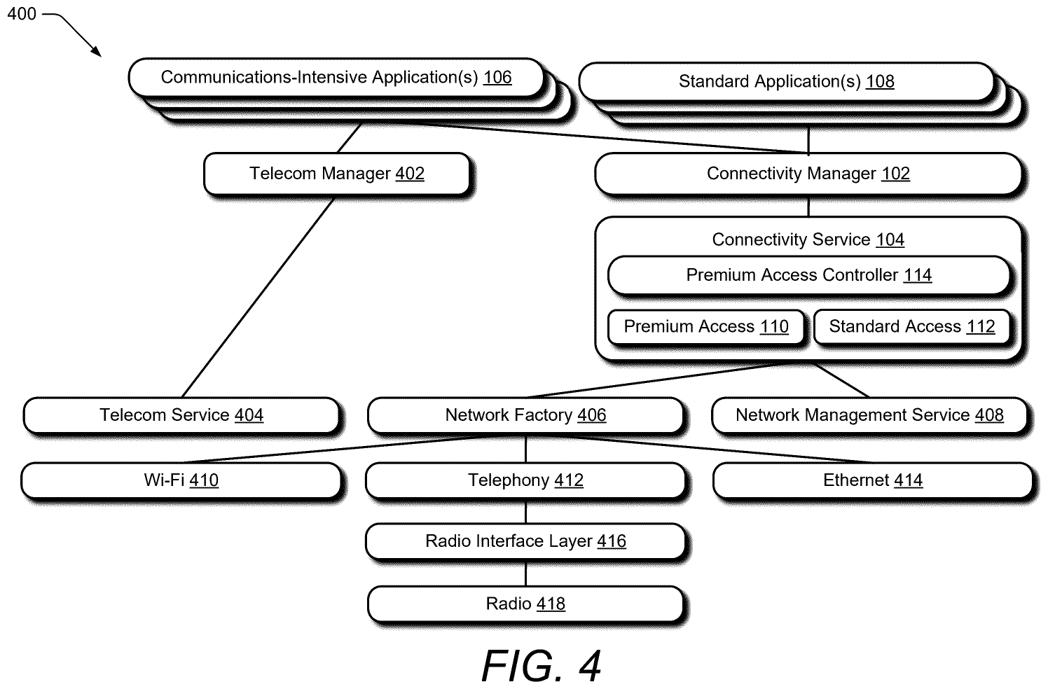

FIG. 4 is a block diagram of a communications architecture 400 of a communications device that incorporates the communications system 100 with the connectivity manager 102 of FIG. 1. As previously described, the communications-intensive applications 106 and the standard applications 108 communicate with the connectivity manager 102. Some of the communications-intensive applications 106, such as OTT applications, may also communicate with the telecommunications manager 402 (“telecom manager” in FIG. 4) that interacts with a carrier's telecommunications service 404 (“telecom service” in FIG. 4) to indicate to the telecommunications manager 402 that they are available to receive or make calls. As also previously described, the connectivity manager 102 operates with the connectivity service 104 and the premium access controller 114 to provide access to the premium access 110 or allow the connectivity service 104 to connect the applications to the standard access 112.

The connectivity service 104 works with a network factory 406 and a network management service 408 to identify availability of and access to network services to determine whether and to what extent the premium access 110 is available. For example, the network factory 406 may monitor and coordinate with a Wi-Fi interface 410, a telephony interface 412, and an Ethernet interface 414 to send and receive data. The availability and capability (e.g., connectivity, signal strength, bandwidth, etc.) of the services provided by the interfaces 410, 412, and/or 414 may be determine the potential availability of the premium access 110 for use by the communications-intensive applications 106. The telephony interface 412, in turn, communicates with a radio interface layer (RIL) 416 that works with a radio 418 to provide wireless communications services. The network management service 408 may determine what networks to use depending on the user's location relative to a mobile carrier's area of service.

### Operation of the Connectivity Manager

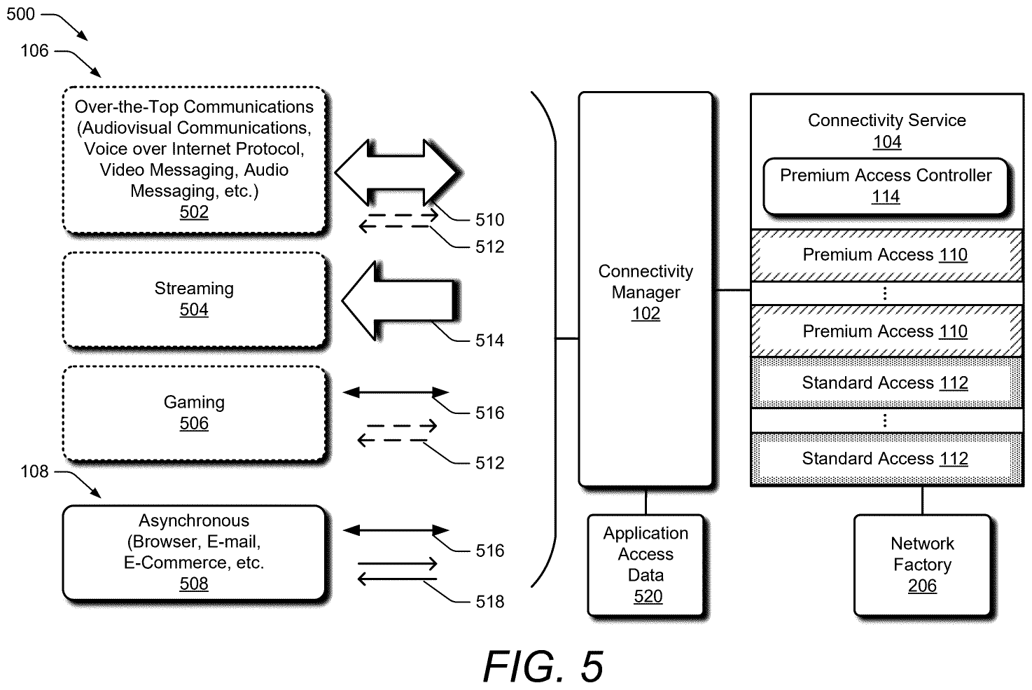

FIG. 5 is a schematic diagram of a system 500 in which the connectivity manager 102 coordinates with the communications-intensive applications 106, standard applications 108, and the connectivity service 104 to provide for association with the premium access 110. The connectivity manager 102 works with the applications 106 and 108 to assess their communications needs in determining which, if any, of the applications 106 and 108 should be associated with the premium access 110.

The communications-intensive applications 106 may include, for example, over-the-top (OTT) communications applications 502, such as audiovisual applications, voice over Internet Protocol applications (VOIP), video messaging applications, and audio messaging applications. Popular OTT applications include WhatsApp, Zoom, and Google Meet. These applications may require high download and upload bandwidth, as represented by large double-ended arrow 510. In addition, to minimize lag in exchange of ingoing and outgoing dialog, it may be desirable to provide reduced latency, as represented by dashed arrows 512.

The communications-intensive applications 106 also may include streaming applications 504 that display motion-video ranging from short clips to feature-length films. Streaming applications 504 may require significant download bandwidth, as represented by large inbound arrow 514. The communications-intensive applications 106 may also include gaming applications 506. Gaming applications 506 may use locally-generated audiovisual data. Thus, ordinary bandwidth, represented by dual-ended arrow 516, may be sufficient for satisfactory operation of the gaming applications 506. However, when the gaming application 506 is a multiplayer, network game, the gaming applications may require reduced latency 512.

The standard applications 108 may include asynchronous applications 508 such as browser, email, e-commerce, and similar applications. While asynchronous applications 508 may offer faster response time and, thus, may benefit from increased bandwidth 510 and reduced latency 512, increased bandwidth 510 and reduced latency 512 may not be as essential in providing a positive user experience as increased bandwidth 510 and reduced latency 512 are for the communications-intensive applications 106. Thus, ordinary bandwidth 516 and ordinary latency 518 may be sufficient for the asynchronous applications 508.

The connectivity manager 102 may both detect and be responsive to the bandwidth 510, 514, and 516 and latency 512 and 518 attributes to determine which of the applications 106 and 108 should be associated with the premium access 110 or the standard access 112 through the connectivity service 104. In aspects, the connectivity manager 102 detects and/or collects the bandwidth 510, 514, and 516 and latency 512 and 518 attributes as part of a process of generating a store of application access data 520. The application access data 520 may be used by the connectivity manager 102 to coordinate with the premium access controller 114 of the connectivity service 104 in determining which of the applications 106 and/or 108 should be associated with the premium access 110 or the standard access 112.

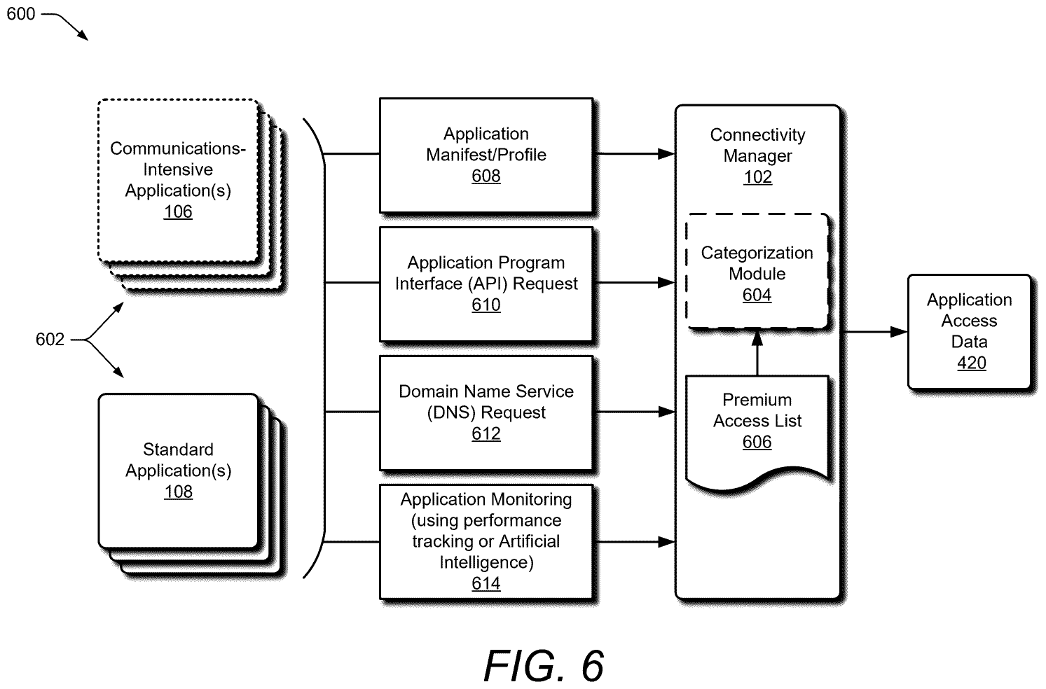

FIG. 6 is a schematic diagram of a system 600 showing interaction of the connectivity manager 102 with applications 602 and data associated with or generated by the applications 602 to identify communications-intensive applications to be associated with the premium access 110 (see FIGS. 1-4). The connectivity manager 102 may include or be associated with a separate categorization module 604. The categorization module 604 may be assigned or delegated the task of evaluating or tracking the data associated with and/or produced by the applications 602 in classifying applications as communications-intensive applications 108 or standard applications 108. The collection and analysis of application data by the connectivity manager 102 and/or the categorization module 604 may be performed on the user's communications device to protect user privacy. In implementations, the user may be provided with notice and an opportunity to consent to this functionality, and may be provided with controls to enable or disable the automatic association feature or aspects of the application monitoring.

The data associated with applications 602 may include, for example, a premium access list 606 that identifies which of the applications 602 have been previously designated as communications-intensive applications 106 (see FIG. 1) for association with the premium access 110. The premium access list 606 may include communications-intensive applications 106 identified by the developers of the communications system 100 and the connectivity manager 102 (see FIG. 1). The premium access list 606 may include OTT communications applications 502, streaming applications 504, gaming applications 506 (see FIG. 5) or other applications that, because of high-bandwidth or reduced-latency requirements, are known to benefit from the premium access 110. The premium access list 606 may be included in the communications system 100 when delivered to users and/or may be subsequently updated by the developers.

The data associated with applications 602 that identifies some of the applications 602 as communications-intensive applications 106 also may include application manifest or profile data 608 that includes metadata descriptive of the applications 602 and their properties. The application manifest or profile data 608 may identify hardware or software support needed, which may include information about bandwidth and/or latency objectives or requirements. The connectivity manager 102 and/or the categorization module 604 may access the application manifest or profile data 608 of the applications 602 in determining if the applications 602 should be categorized as communications-intensive applications 106 that should be associated with the premium access 110 when available.

In addition to reviewing preexisting data about the applications 602, the connectivity manager 102 and/or the categorization module 604 may monitor data generated by or used by the applications 602 in determining if they should be classified as communications-intensive applications 106. For example, application program interface (API) requests 610 issued by the applications 602 to access communications resources may indicate whether the applications 602 issuing the API requests should be categorized as communications-intensive applications 106. Similarly, domain name service (DNS) requests 612 to communications-intensive services, such as OTT communications servers or streaming media sites may indicate whether the applications 602 issuing those DNS requests 612 should be categorized as communications-intensive applications 106.

The connectivity manager 102 and/or the categorization module 604 also may conduct application monitoring to monitor the quantity of communications data received or sent by the applications 602 to determine whether the applications 602 should be categorized as communications-intensive applications 106. The volume of communications data received and/or sent by the applications 602 may be compared to predetermined thresholds to determine if particular applications 602 should be categorized as communications-intensive applications 106. In aspects, artificial intelligence may be employed by the connectivity manager 102 and/or the categorization module 604 to categorize the applications 602. For example, a neural network may include nodes that represent particular data communications behaviors or data volumes such that when particular usage levels, patterns, and/or combinations of such indicators may result in applications 602 being identified as communications-intensive applications 106. The neural network or other AI used for application monitoring 614 also may be configured to determine whether applications 602 are included in the premium access list 606, information from the application manifest/profile 608, API requests 610, and DNS requests 612 in classifying applications 602 as communications-intensive applications 106.

In addition to categorizing the applications 602, the connectivity manager 102 and/or the categorization module 604 also may assign relative priorities to the applications 602 based on the same data used to categorize the applications 602. For example, based on the inclusion of applications 602 in the premium access list 606, information from the application manifest/profile 608, API requests 610, DNS requests 612, and application monitoring 614, it may determine which of the communications-intensive applications 106 are assigned highest priorities for premium access, which may be a limited resource.

Determinations on the categorization and/or prioritization of applications 602 made by the connectivity manager 102 and/or the categorization module 604 may be stored in the application access data 520. Although the application access data 520 may be periodically or continually adjusted based on usage, the application access data 520 may provide ongoing direction as to which of the applications 602 are regarded as communications-intensive applications 106 to be associated with or given priority in being associated with the premium access 110.

### Example Operation of the Connectivity Manager in Associating Priority Access

FIGS. 7A-7D are schematic diagrams representing an example of the connectivity manager 102 associating applications with the premium access 110 and the standard access 112 network services. For purposes of the foregoing example, it is depicted that the premium access 110, potentially in the form of a 5G premium slice, is available for one application to use at a time, while multiple applications may be associated with the standard access 112. The availability of the premium access 110 for only a single application is solely for the sake of example in how the potentially-limited resource of the premium access 110 may be allocated by the connectivity manager 102; the premium access 110 may be available for multiple applications to use at one time and the connectivity manager 102 may prioritize and/or determine which of the applications are associated with the premium access 110 accordingly.

FIG. 7A shows a first configuration 700 in which three applications are available. Two communications-intensive applications 106 (see FIG. 1) include a communications application 702, such as an OTT conferencing or calling application and a streaming media application 704, such as a subscription-based audiovisual streaming application. A standard application 108 includes an email client 706, a typical asynchronous communications application. In the first configuration 700, only the email client 706 is active, as represented by the email client 706 being surrounded by a dashed outline 708.

In the example of FIG. 7A, because the other applications 702 and 704 are not active, the connectivity manager 102 may associate (as represented by an arrow 710) the email application 706 with the premium access 110 by default. Although the email application 706 is a standard application 112, because the other applications 702 and 704 are not active, the email application 706 is associated 710 with the premium access 110 by default. In other aspects, such as implementations in which the premium access 110 is a restricted resource (e.g., a user is allotted only a certain amount of the premium access 110 data for a given time period), the email application 706 may only be associated with the standard access 112 to preserve the quantity of data allotted for the premium access 110.

Continuing with the example of FIG. 7A, FIG. 7B shows a second configuration 712 in which the streaming application 704 has also become active, as represented by the streaming application 704 being outlined with a dashed outline 714. Because the streaming application 704 has been identified as a communications-intensive application 106 (see FIG. 1) in the application access data 420 according to one of the techniques previously described with reference to FIG. 5. The connectivity manager 102 therefore associates the streaming application 704 with premium access 110, as represented by an arrow 716). Because the email application 706 is not a communications-intensive application 106 and thus may be prioritized for premium access 110 by the connectivity manager 102 and/or the application access data 420, the still-active email application 706 is disassociated from the premium access 110 and is associated with the standard access 112, as represented by arrow 718.

In aspects, the connectivity manager 102 provides a signal (as represented by arrow 720) to the streaming application 704 that it is associated with the premium access 110. Communications-intensive applications 106, such as the streaming application 704, may benefit from being associated with the premium access 110 by being able to offer higher resolution video, higher-resolution audio, or other enhancements. By providing the signal 720 to the streaming application 704, the streaming application 704 may adjust its operations to take advantage of the capability offered by association with the premium access 110. To potentially improve user satisfaction, the association with the premium access 110 may be signaled to a user, as further described with reference to FIG. 7B.

FIG. 7C shows a third configuration 722 in which the communications application 702 has become active, as represented by the communications application 702 being outlined with a dashed outline 724. In the example of FIG. 7C, the communications application 702 is prioritized by the connectivity manager 102 and, upon becoming active, is associated with the premium access 110 as represented by arrow 726, in effect, switching or replacing the streaming application 704 to being associated with the premium access 110. The communications application 702 may be prioritized by the connectivity manager 102 over the streaming application 704, thus, the connectivity manager 102 associates the streaming application 704 with the standard access 112 as represented by arrow 728. The connectivity manager 102 provides a signal 730 to the communications application 702 to indicate to the communications application 702 that it is able to take advantage of the capability offered by the premium access 110.

As the connectivity manager 102 adjusted which of the applications 702, 704, and 706 is associated with premium access in the configurations 700, 712, and 722 of FIGS. 7A, 7B, and 7C, respectively, as applications become inactive, the connectivity manager 102 similarly may adjust which of the applications 702, 704, and 706 are associated with the premium access 110 or the standard access 112. FIG. 7D shows a configuration 732 in which the communications application 702 has become inactive (as represented by the removal of the dashed outline 724 of FIG. 7C). Because the communications application 702 is inactive and, thus, no longer uses the premium access 110, the connectivity manager 102 may be configured to reassociate the streaming application 704 with the premium access 110 as represented by arrow 734, thereby switching the streaming application 704 to being associated with the premium access 110. The connectivity manager 102 also again presents a signal 736 to the streaming application 704 that it is associated with the premium access 110. Thus, the connectivity manager 102 associates, disassociates, and/or reassociates applications with the premium access 110 or the standard access 112 to provide the capabilities of the premium access 110 to selected applications that can most benefit from the premium access 110.

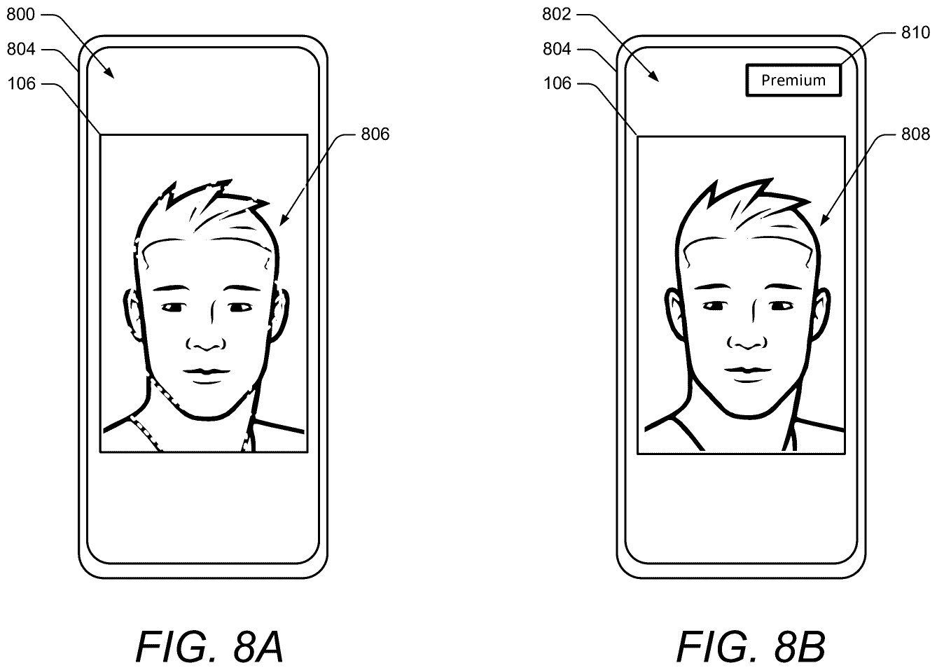

As previously mentioned with reference to FIGS. 7B through 7D, the connectivity manager 102 may notify applications associated with the premium access 110 (see FIG. 1), so that the applications can take advantage of the capability offered by the premium access 110 and to notify users that they are benefitting from the premium access 110. FIGS. 7A and 8B are screen displays 800 and 802, respectively, of a communications device 804, such as a mobile telephone, representing results of a communications-intensive application 106 being associated with the premium access 110 (see FIG. 1). The communications-intensive application 106 may include an OTT communications application that provides audiovisual communications, such as video calling that allows a user (not shown) of the communications device 804 to see video of the other party or parties 804 to the call.

FIG. 8A shows a screen display 800 from the communications-intensive application 106 when the communications-intensive application 106 is associated with the standard access 112 (see FIG. 1). In the example of FIG. 8A, the communications-intensive application 106 yields a pixelated image of a remote party 806 to a video call. For illustration, it is assumed that the pixelated image of the remote party 806 is pixelated because the bandwidth afforded by the standard access 112 does not support video higher resolution than what is represented in the pixelated image of the remote party 806.

By contrast, FIG. 8B shows a screen display 802 from the communications-intensive application 106 when the communications-intensive application 106 is associated with the premium access 110 (see FIG. 1). In the example of FIG. 8B, the communications-intensive application 106 yields a sharp, non-pixelated image of a remote party 808 to the video call. For illustration, it is assumed that the improved, non-pixelated image of the remote party 808 is made possible by the greater bandwidth afforded by the premium access 110.

In addition, the screen display 802 of FIG. 8B includes a premium access indicator 810. In the event that the improved, non-pixelated image of the remote party 808 does not allow the user to appreciate the benefit of premium access, the premium access indicator 810 informs the user that their application is associated with the premium access 110.

### Example Call Flow in Associating Priority Access

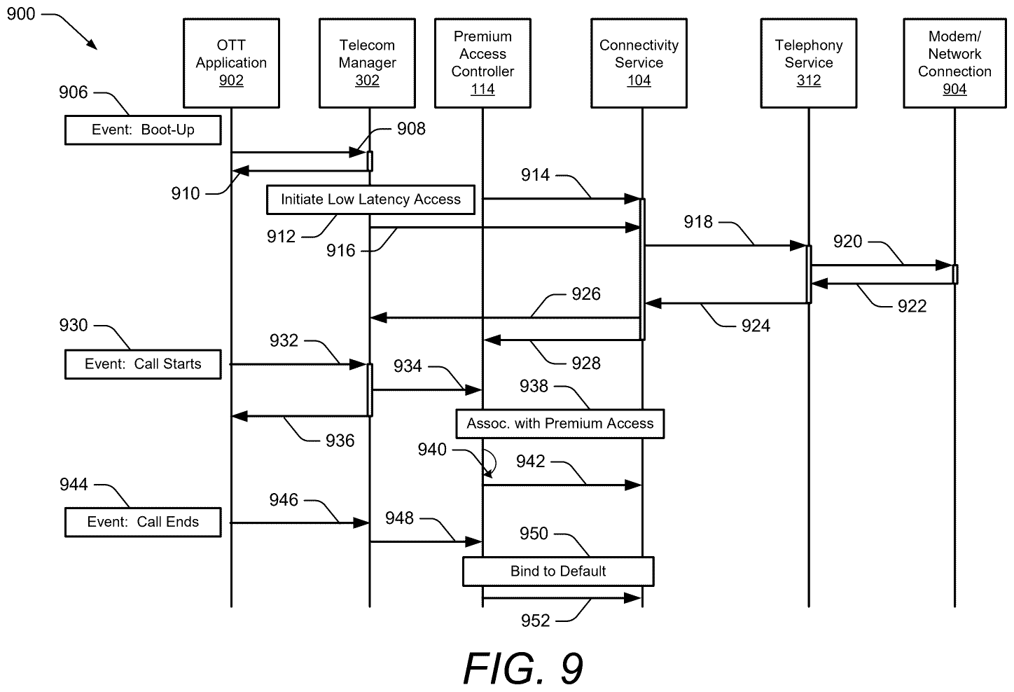

FIG. 9 is an example call flow diagram 900 in a mobile telephone representing management of OTT calls of a communications-intensive application 106 with standard access 112 at boot-up then associating the communications-intensive application 106 with the premium access 110 when the communications-intensive application 106 is active using aspects of the communications architecture 400 that incorporates the connectivity manager 102 and the connectivity service 104 (see FIGS. 1 and 4). The call flow diagram 900 illustrates management of a call placed using an OTT application 902 is managed through the telecommunications manager 402, the connectivity manager 102, the connectivity service 104, the telephony service 312, and the modem/network connection 904.

A first event includes boot-up of the mobile telephone 906. At 908, the OTT application 902 is registered with the telecommunications manager 4302 as being able to make or receive calls (e.g., with command TM.registerPhoneAccount). At 910, the telecommunications manager 402 reports a result of the registration 908 to the OTT application 902 which, for this example, is presumed to be a success.

A second event includes the connectivity manager 102, operating automatically and transparently to the OTT application 902, associating the OTT application 902 with initiation of low latency access 912 with the connectivity service 104 (e.g., with command registerNetworkCallback(cap=LOW_LATENCY)). At 914, the premium access controller 114 registers the OTT application 902 with the connectivity service 104 for low-latency access to receive callbacks (e.g., with command registerNetworkCallback(cap=LOW_LATENCY)). At 916, the telecommunications manager 402 issues a low-latency network request (e.g., with command requestNetwork(cap=LOW_LATENCY)). At 918, the connectivity service 104, again operating automatically and transparently to the OTT application 902, requests low-latency access to the telephony service 412 (e.g., with command needForNetwork(cap=LOW_LATENCY)). At 920, the telephony service 412 establishes a data call (for data service for the OTT application 902) with the modem/network connection 904 (e.g., with command setupDataCall(appid=LOW_LATENCY)).

At 922, for purposes of this example, the modem/network connection 904 reports success of the request to establish a data call. At 924, in response to establishment of the data call at 922, the telephony service 412 reports to the connectivity service 104 that the low-latency service requested at 918 has been granted (e.g., with message markCorrected (network(cap=LOW_LATENCY))). At 926, the connectivity service 104 reports to the telecommunications manager 402 that the low-latency access has been made available (e.g., with message onAvailable(network(cap=LOW_LATENCY))). At 928, the connectivity service 104 also reports to the premium access controller 114 that the low-latency access has been made available (e.g., with message onAvailable(network (cap=LOW_LATENCY))).

A third event 930 begins when a call starts with, at 932, issuance of a command from the OTT application 902 to the telecommunications manager 402 (e.g., with command TM.placeCall( )). At 934, the telecommunications manager 302 reports to the premium access controller 114 that the call has been initiated (e.g., with message onCallAdded(call)). At 936, the telecommunications manager 302 reports to the OTT application that the call has been created (e.g., with message onCreateOutgoingConnection(request)).

A fourth event 938 begins with connectivity manager 102 instructing the premium access controller 114 seeking to access the premium access 110 (e.g., a 5G premium slice). At 940, the premium access controller 114 requests the identifier for the call (e.g., with command fetchUid (call)). At 942, the premium access controller 114 instructs the connectivity service 104 to associate the call with the premium access 110 (e.g., with command setPerAppNetworkPreference). With the call associated with the premium access 110 by the premium access controller 114, the call proceeds.

A fifth event 944 occurs with the call ending with, at 946, a command to disconnect the call (e.g., with command call.hangup( )). At 948, the telecommunications manager 402 directs the premium access controller 114 to remove the call (e.g., with command onCallRemoved(call)).

Finally, a sixth event 950 occurs subsequent to the call by returning to the standard access 112 by disassociating from the premium access 110 (e.g., by issuing the command removeperAppNetwork(Preference), essentially undoing the association with the premium access at 942.

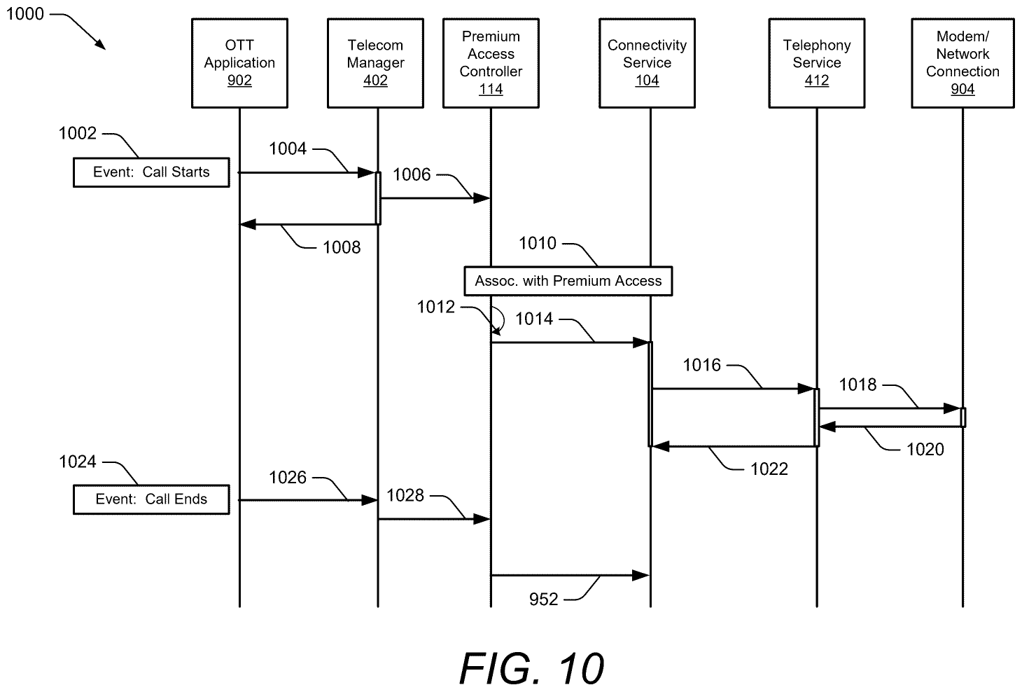

FIG. 10 is an example call flow diagram 1000 in a mobile telephone showing how OTT calls are associated with the premium access 110 when the communications-intensive application 106 is active using aspects of the communications architecture 400 that incorporates the connectivity manager 102 and the connectivity service 104 (see FIGS. 1 and 4) without associating the communications-intensive application 106 with the standard access 112 as described with reference to FIG. 9. The call flow diagram 1000 is similar to the call flow diagram of FIG. 9 once the OTT application is engaged in a call.

A first event 1002 begins when a call starts with, at 1004, issuance of a command from the OTT application 1002 to the telecommunications manager 402 (e.g., with command TM.placeCall( )). At 1006, the telecommunications manager 402 reports to the premium access controller 114 that the call has been initiated (e.g., with message onCallAdded(call)). At 1008, the telecommunications manager 302 reports to the OTT application 902 that the call has been created (e.g., with message onCreateOutgoingConnection(request)).

A second event 1010 begins with connectivity manager 102 instructing the premium access controller 114, seeking to access the premium access 110. At 1012, the premium access controller 114 requests the identifier for the call (e.g., with command fetchUid(call)). At 1014, the premium access controller 114 instructs the connectivity service 104 to associate the call with the premium access 110 (e.g., with command setPerAppNetworkPreference). With the call associated with the premium access 110 by the premium access controller 114, at 1016, the connectivity service 104, again operating automatically and transparently to the OTT application 902, requests low-latency access to the telephony service 412 (e.g., with command needForNetwork(cap=LOW_LATENCY)). At 1018, the telephony service 412 establishes a data call (for data service for the OTT application 902) with the modem/network connection 904 (e.g., with command setupDataCall(appid=LOW_LATENCY)).

At 1020, the modem/network connection 904 reports success of the request to establish a data call. At 1022, in response to establishment of the data call at 1022, the telephony service 412 reports to the connectivity service 104 that the low-latency service requested at 1018 has been granted (e.g., with message markCorrected (network(cap=LOW_LATENCY))) and the call proceeds.

A third event 1024 occurs with the call ending with, at 1026, a command to disconnect the call (e.g., with command call.hangup( )). At 1028, the telecommunications manager 402 directs the premium access controller 114 to remove the call (e.g., with command onCallRemoved(call)). At 1030, the premium access controller 114 disassociates the OTT application 902 from the premium access 110 (e.g., by issuing the command removeperAppNetwork (Preference), essentially undoing the association with the premium access at 942.

Example Method of Associating an Application with Premium Access

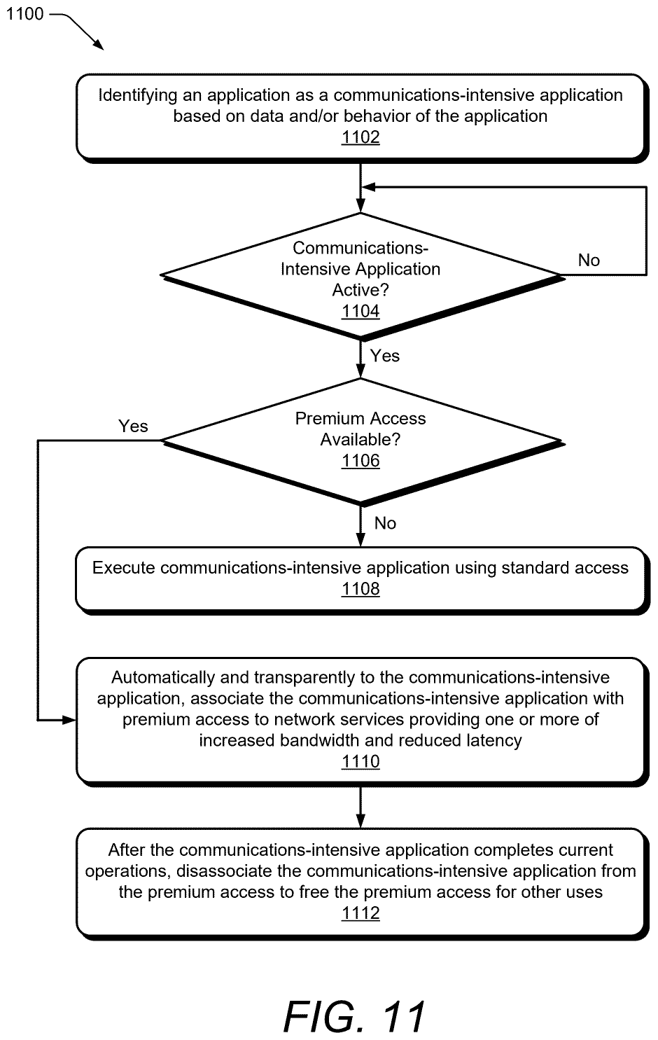

FIG. 11 is a flow diagram 1100 of an example method of automatically associating a communications-intensive application with premium access to network services. At 1102, an application is identified as a communications-intensive application based on data and/or behavior of the application, as previously described with reference to FIG. 6. At 1104, it is determined if the communications-intensive application is active, such as by an OTT communications application seeking to place a call. At 1106, it is determined whether premium access is available for potential use by the communications-intensive application.

If it is determined at the block 1106 that premium access is not available, at 1108, the communications-intensive application is executed using standard access. On the other hand, if it is determined at the block 1106 that premium access is available, at 1110, automatically and (while being potentially non-transparent to the user) transparently to the communications-intensive application, the communications-intensive application is associated with premium access to network services to provide one or more of increased bandwidth and reduced latency to the communications-intensive application. In some aspects, a notification may be provided to the application to allow it to adapt its performance to the premium access. At a block 1112, after the communications-intensive application completes current operations, such as completion of an OTT call or session, the communications-intensive application is disassociated from the premium access to free the premium access for other uses.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques for enhancing Quality of Service (QOS) of communications-intensive applications by automatically associating the applications with premium access have been described in language specific to certain features and/or methods, the subject of the appended claims is not necessarily limited to the specific features or methods described. Rather, the specific features and methods are disclosed as example implementations of systems and techniques for enhancing Quality of Service (QOS) of communications-intensive applications by automatically associating the applications with premium access.

What is claimed is:

1. A communications system comprising:
a connectivity service configured to provide one or more applications with standard access or premium access to communications services, the premium access operable to provide at least one of increased bandwidth and reduced latency, the one or more applications including a communications-intensive application configured to provide enhanced functionality when connected with the premium access;
a premium access controller associated with the connectivity service, the premium access controller being configured to identify the communications-intensive application for association with the premium access; and
a connectivity manager configured to interact with the applications to identify the communications-intensive application and to cause the premium access controller of the connectivity service to automatically associate the communications-intensive application to the premium access.

2. The communications system of claim 1, wherein the premium access includes one of:
a premium slice in a fifth-generation (5G) network;
premium data or priority data in a fourth-generation (4G) network; or
premium connectivity in a long-term evolution (LTE) network.

3. The communications system of claim 1, wherein the premium access includes a high-bandwidth or low-latency portion of:
an Internet Multimedia Subsystem (IMS); or
a satellite communications system.

4. The communications system of claim 1, wherein the connectivity manager is configured to associate the communications-intensive application to the premium access without the communications-intensive application including control signals to request the premium access.

5. The communications system of claim 1, wherein the communications-intensive application includes:
a communications application including an audiovisual communications application, an over-the-top (OTT) communications application, a voice over Internet Protocol (VOIP) application, a video messaging application, or an audio messaging application;
a video streaming application; or
a gaming application.

6. The communications system of claim 1, wherein the connectivity manager is configured to identify the communications-intensive application based on communications data determined from the communications-intensive application.

7. The communications system of claim 6, wherein the communications data includes:
application manifest or application profile data descriptive of the communications-intensive application;
an application program interface request issued by the communications-intensive application;
a domain name system (DNS) request issued by the communications-intensive application for a service associated with communications-intensive execution; or
performance monitoring of the communications-intensive application.

8. The communications system of claim 7, wherein the connectivity manager is configured to conduct performance monitoring of the communications-intensive application using performance tracking or artificial intelligence (AI).

9. The communications system of claim 7, wherein the connectivity manager is configured to generate and access application access data to identify the communications-intensive application.

10. The communications system of claim 1, wherein the connectivity manager is configured to prioritize which of a plurality of communications-intensive applications is associated with the premium access.

11. The communications system of claim 10, wherein the premium access controller is configured to replace a first communications-intensive application accessing the premium access with a second communications-intensive application having a higher priority than the first communications-intensive application when the second communications-intensive application is active.

12. The communications system of claim 11, wherein the premium access controller is configured to switch the first communications-intensive application to the standard access when the second communications-intensive application having the higher priority than the first communications-intensive application is active.

13. The communications system of claim 11, wherein the premium access controller is configured to switch an application associated with the standard access to the premium access when a previously-associated communications-intensive application associated with the premium access becomes inactive.

14. A communications system implemented on a communications device, the system comprising:
a processor; and
a memory storing instructions that, when executed by the processor, cause the system to implement:
a connectivity service configured to provide one or more applications with standard access or premium access to communications services, the premium access operable to provide at least one of increased bandwidth and reduced latency, the one or more applications including a communications-intensive application configured to provide enhanced functionality when connected with the premium access;
a premium access controller associated with the connectivity service, the premium access controller being configured to identify the communications-intensive application for association with the premium access; and
a connectivity manager configured to:
monitor one or more of the applications to identify a communications-intensive application, wherein the identifying is performed without the communications-intensive application being modified to request the premium access and is based on one or more of:
an application manifest or application profile data descriptive of the communications-intensive application;
an application program interface request issued by the communications-intensive application;
a domain name system (DNS) request issued by the communications-intensive application for a service associated with communications-intensive execution; or
performance monitoring of the communications-intensive application; and
in response to identifying the communications-intensive application, cause a premium access controller to automatically associate network traffic with the premium access.

15. A method for enhancing quality of service on a communications device, the method comprising:
by a connectivity manager executing on the communications device:
identifying a communications-intensive application from among one or more applications by monitoring:
an application manifest or application profile data descriptive of the communications-intensive application;
an application program interface request issued by the communications-intensive application;
a domain name system (DNS) request issued by the communications-intensive application for a service associated with communications-intensive execution; or
performance monitoring of the communications-intensive application; and
in response to identifying the communications-intensive application, automatically associating network traffic from the communications-intensive application with the premium access without applying or necessitating modification of the communications-intensive application.
